(19) United States
(12) Patent Application Publication
(10) Pub. No.: US 2018/0102056 A1
(43) Pub. Date: Apr. 12, 2018

(54) Device, System, and Method for Managing Regional Diversion

(71) Applicant: PASSUR Aerospace, Inc., Stamford, CT (US)

(72) Inventors: William Leber, Stamford, CT (US); Robert Junge, Stamford, CT (US); Mark Libby, Stamford, CT (US); Ron Dunsky, Stamford, CT (US)

(21) Appl. No.: 15/782,447

(22) Filed: Oct. 12, 2017

Related U.S. Application Data
(60) Provisional application No. 62/407,275, filed on Oct. 12, 2016.

(51) Int. Cl. G08G 5/00

(52) U.S. Cl. CPC G08G 5/0021; G08G 5/0043; G08G 5/0039

(57) ABSTRACT

A device, system, and method manages regional diversions. The method perform at a diversion server includes determining whether a diversion is to be used for an aircraft based on a primary expected operating capability of a primary airport that is a destination for the aircraft in transit. The method includes, when a diversion is to be used, selecting a secondary airport to which the aircraft is to be diverted, the secondary airport being selected based on a secondary expected operating capability. The method includes scheduling the diversion for the aircraft to the secondary airport.

### PRIORITY CLAIM/INCORPORATION BY REFERENCE

The present application claims priority to U.S. Provisional Patent Application 62/407,275 filed on Oct. 12, 2016 entitled “System and Method for Managing Regional Diversion Management” naming William Leber, Robert Junge, Mark Libby, and Ron Dunsky as inventors, and hereby incorporates, by reference, the entire subject matter of this application.

### BACKGROUND INFORMATION

An airport may service many aircraft for many different airlines or owners. The airport may become saturated servicing these many planes. For example, delays may create a cascade effect where a delay causes an aircraft that is intended to be at the airport for a certain duration to remain at the airport for an extended duration. A further aircraft may be affected by this delay and itself be delayed and remain at the airport for a respective extended duration beyond an intended duration. Accumulation of such effects may lead to decreased efficiency at the airport. For example, an aircraft scheduled to use the airport may not be capable of landing and may be required to fly in a holding pattern for an unintended amount of time. When the holding aircraft is not capable of being accommodated at the airport and all possible resolutions at the airport are depleted, the aircraft may be required to be diverted to another airport.

Conventional airport systems may provide information and estimates to stakeholders of the aircrafts using the airport (e.g., air traffic controllers, airlines, etc.). However, when diversions are required, the diversion resolution may only be reached after the fact in a reactive fashion. Thus, the impact to the efficiency at the airport may have already occurred. Furthermore, diversions to another airport may require communications between the two airports at the time a diversion is requested. Therefore, the use of the diversion resolution may further delay the holding aircraft.

### SUMMARY

The exemplary embodiments are directed to a method, comprising: at a diversion server: determining whether a diversion is to be used for an aircraft based on a primary expected operating capability of a primary airport that is a destination for the aircraft in transit; when a diversion is to be used, selecting a secondary airport to which the aircraft is to be diverted, the secondary airport being selected based on a secondary expected operating capability; and scheduling the diversion for the aircraft to the secondary airport.

The exemplary embodiments are directed to a diversion server, comprising: a transceiver configured to receive an identification of a primary airport, the primary airport being a destination for an aircraft in transit; and a processor determining whether a diversion is to be used for the aircraft based on a primary expected operating capability of the primary airport, when a diversion is to be used, the processor selecting a secondary airport to which the aircraft is to be diverted, the secondary airport being selected based on a secondary expected operating capability, the processor scheduling the diversion for the aircraft to the secondary airport.

The exemplary embodiments are directed to a method, comprising: at a diversion server: receiving an identification of a primary airport, the primary airport being a destination for an aircraft in transit; determining whether a diversion is to be used for the aircraft based on a primary expected operating capability of the primary airport; when a diversion is to be used, generating a notification to be shown on a user interface to alert a user for the use of a proactive diversion; and receiving a diversion resolution input indicating a secondary airport to which the primary airport is to be diverted.

### BRIEF DESCRIPTION OF THE DRAWINGS

FIG. 1 shows an exemplary system for managing diversions according to the exemplary embodiments.

FIG. 2 shows an exemplary diversion server of the system of FIG. 1 according to the exemplary embodiments.

FIG. 3 shows an exemplary user interface provided by the diversion server of the system of FIG. 1 according to the exemplary embodiments.

FIG. 4 shows an exemplary airport icon in the user interface of FIG. 3 according to the exemplary embodiments.

FIG. 5 shows an exemplary probability screen in the user interface of FIG. 3 according to the exemplary embodiments.

FIG. 6 shows an exemplary user interface with an airport window according to the exemplary embodiments.

FIG. 7 shows an exemplary user interface with an aircraft window according to the exemplary embodiments.

FIG. 8 shows an exemplary method of managing diversions according to the exemplary embodiments.

### DETAILED DESCRIPTION

The exemplary embodiments may be further understood with reference to the following description of the exemplary embodiments and the related appended drawings, wherein like elements are provided with the same reference numerals. The exemplary embodiments are related to a device, system, and method for managing diversions at a primary airport. Specifically, an aircraft scheduled to use the primary airport may be diverted to a secondary airport in a proactive manner. As will be described in further detail below, the exemplary embodiments provide a mechanism to determine when a diversion may be necessary, identifying one or more aircraft to be diverted, identifying one or more secondary airports to which the identified aircraft may be diverted, and determining how the diversions are to be assigned.

For illustrative purposes, the primary airport is used herein to describe an airport in which a diversion is to be performed. For example, an aircraft scheduled to use the primary airport may be redirected to a different airport. The secondary airport is used herein to describe an airport to which a diversion is redirected. For example, an aircraft may be redirected from the primary airport to the secondary airport. Accordingly, the primary and secondary airports may be relative terms. For example, in a first scenario, a first airport may represent a primary airport and a second airport as well as a third airport may represent a secondary airport relative to the first airport. However, in a second scenario, the second airport may represent a primary airport and the first airport as well as a fourth airport may represent a secondary airport relative to the second airport. The determination of the relationship of primary and secondary may be based on a manual determination (e.g., as determined by representatives of the airports, airlines, etc.), an agreement among airports, an automated determination (e.g., based on geographic regions), or a combination thereof. Thus, the primary airport may have a predetermined list of one or more secondary airports that may be available to receive diversions from the primary airport. In fact, assuming a capability factor is met, the secondary airports may also be determined based on a variety of factors (e.g., the reason for the diversion, the airline associated with aircraft being diverted, whether the secondary airport is being affected by the same event as the primary airport such as a storm, etc.).

Initially, it is noted that the exemplary embodiments are described with regard to diversions from a first airport to a second airport. However, the diversion being a resolution to a set of current conditions is only an exemplary scenario. The exemplary embodiments may be implemented and/or modified to be used for any scenario in which a minimum operating parameter such as efficiency is to be maintained at a given location, particularly for aircrafts and airports.

It is also noted that the exemplary embodiments are described with regard to diversions being a resolution to the current conditions at an airport. Accordingly, there may be an underlying assumption that any internal resolution that may be accomplished at the airport is not available and an aircraft is to be diverted instead. Those skilled in the art will understand an internal resolution may also be used and that the diversion may be a final resort. For example, an internal resolution may be to reassign a new gate from an intended gate to an aircraft. In another example, arrivals and departures may be expedited to return to a predetermined schedule of operations at the airport. The exemplary embodiments may be configured to utilize and/or consider these internal resolutions in a manner consistent to those skilled in the art. However, for illustrative purposes, the internal resolutions may not be available and the exemplary embodiments may conclude that the diversion may be used.

The exemplary embodiments provide a mechanism to manage an airport, particularly through managing aircraft diversions. As will be described in further detail below, the mechanism according to the exemplary embodiments may ensure that all key stakeholders (e.g., airlines, airport airside operations, airport terminal operations, the Federal Aviation Administration (FAA), Customs and Border Patrol (CBP), concessionaires, ground handlers, etc.) are prepared for a diversionary event. The mechanism also ensures that the stakeholders are provided the same accurate, complete, and relevant information. By providing the right information to the right people at the right time, the exemplary embodiments enable a proactive and predictive manner of determining and handling a diversion prior to an actual need of the diversion arising to maintain an operating efficiency at an airport.

In providing the above features, the exemplary embodiments may ensure that a diversion airport selected to receive a diversion (e.g., a secondary airport associated with a primary airport) is prepared to handle the diversion and that no single secondary airport/set of secondary airports are overwhelmed by a disproportionate number of diversions should there be a plurality of diversions from the primary airport. The exemplary embodiments may also prevent extended tarmac delays with passengers on board an aircraft and decrease the number of holding aircrafts or the time the aircrafts are holding. The exemplary embodiments may further minimize cancellations at a secondary airport due to crew time-outs to achieve a highest completion factor associated with flights that are processed and passengers are provided with expected travel itineraries. By also implementing a quickest possible time to recover from a diversion using a balanced recovery plan, the exemplary embodiments may proactively handle diversions as well as proactively handle effects of the diversions.

As noted above, the exemplary embodiments may provide relevant information to the stakeholders. Specifically, the information may be provided in a plurality of different user interfaces. In a first example, a first type of stakeholder may be an airline. The airline may require knowledge of where aircraft (both their own and others) are being diverted. The airline may also require knowledge of the secondary airport and a capability status (e.g., gates, fuel, deicing fluid, hardstands, etc.). In a second example, a second type of stakeholder may be the CBP, ground handlers, etc. This group may require knowledge of how many diversions are heading toward them, the type of aircraft, the airlines, a likelihood of a crew timing out, etc. In a third example, a third type of stakeholder may be the airport. The airport may require knowledge of when diversions are recovering, the identities of the recovering diversions, whether the diversion has cleared customs, an estimated time of arrival (ETA) to a particular location, etc. In a fourth example, a fourth type of stakeholder may be a general audience including those noted above. This group may request knowledge of a likelihood that a diversion will occur and when.

To properly provide the above information as well as performing automated operations based on a set of rules to determine when a diversion may be required or used (e.g., to maintain a minimum operational efficiency, to compensate for an event at the airport, etc.), to determine how the diversion is to be performed, and to determine how to recover from the diversion, the mechanism according to the exemplary embodiments may generate/utilize a congestion score that indicates whether a diversion is likely to be used at a primary airport, a capability score that indicates a secondary airport's ability to service a diversion, and a gridlock score that may be a subset of the capability score that tracks aircraft inbound and outbound at the secondary airport to indicate when the secondary airport is gridlocked (which may serve as a determination factor when other metrics used in the capability score between multiple secondary airports are substantially similar).

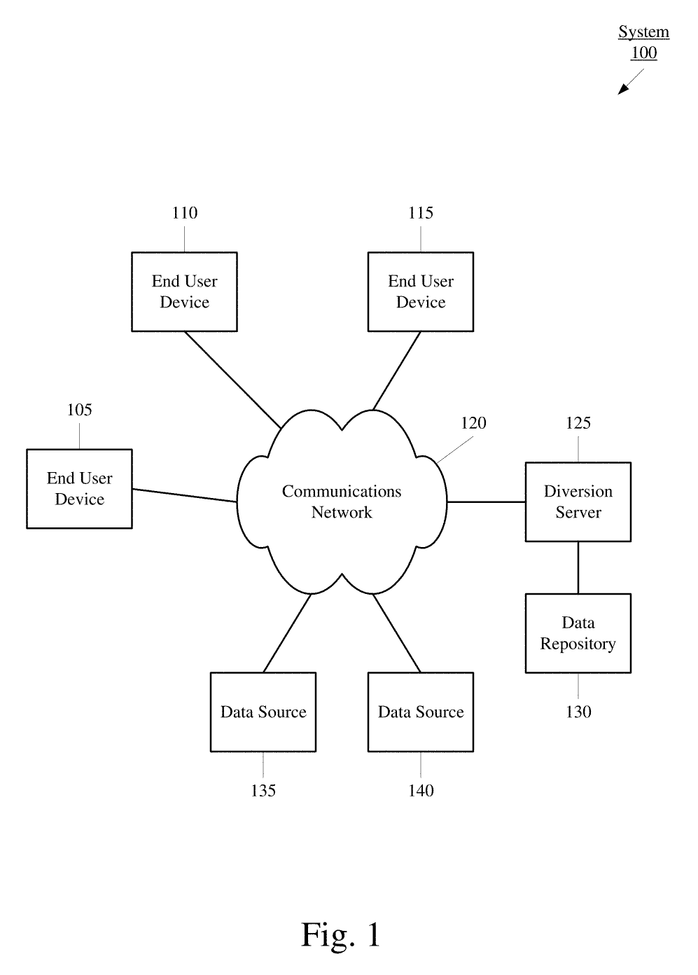

FIG. 1 shows an exemplary system 100 for managing diversions according to the exemplary embodiments. The system 100 relates to a communication between various components involved in managing a diversion and providing information on user interfaces to various users (e.g., stakeholders when a diversion arises). In providing these features according to the exemplary embodiments, the system 100 may include a plurality of end user devices 105-115, a communications network 120, a diversion server 125, a data repository 130, and a plurality of data sources 135-140.

The end user devices 105-115 may be any electronic device associated with respective users utilizing the features of the exemplary embodiments. Specifically, the end user devices 105-115 may be used by the respective users who may have be involved with a diversion and who may view information on a user interface. Accordingly, the end user devices 110-115 may include the necessary hardware, software, and/or firmware to provide any display or the user interface for the features of the exemplary embodiments. For example, the end user devices 110-115 may be stationary devices (e.g., a desktop terminal) or mobile devices (e.g., a tablet, a laptop, etc.). The users may represent any entity that uses the exemplary embodiments such as an airline, an airport, an aircraft, a passenger, crews, FAA, CBP, etc. That is, the users may be individuals or organizations who are stakeholders. The users may also be associated with one or more of airports (e.g., a primary airport, a secondary airport, etc.).

The communications network 120 may be configured to communicatively connect the various components of the system 100 to exchange data. The communications network 120 may represent any single or plurality of networks used by the components of the system 100 to communicate with one another. For example, if the end user device 105 is used at an airport, the communications network 120 may include a private network with which the end user device 120 may initially connect (e.g. an airport network). The private network may connect to a network of an Internet Service Provider (ISP) to connect to the Internet. Subsequently, through the Internet, a connection may be established to other electronic devices. For example, the diversion server 125 may be remote relative to the airport but may be connected to the Internet. Thus, the end user device 105 may be communicatively connected to the diversion server 125. In another example, if the end user device 110 is used at a residence, the communications network 120 may include a network of an ISP to connect to the network. It should be noted that the communications network 120 and all networks that may be included therein may be any type of network. For example, the communications network 120 may be a local area network (LAN), a wide area network (WAN), a virtual LAN (ULAN), a WiFi network, a HotSpot, a cellular network (e.g., 3G, 4G, Long Term Evolution (LTE), etc.), a cloud network, a wired form of these networks, a wireless form of these networks, a combined wired/wireless form of these networks, etc.

It is noted that the exemplary embodiments are described with regard to the end user devices 110-115 utilizing the features of the exemplary embodiments provided by the diversion server 125 using a connection via the communications network 120. For example, the exemplary embodiments may be implemented as a web service on a webpage hosted by the diversion server 125. In another example, the exemplary embodiments may be implemented as an application executed on the end user devices 105-115 but may rely on a data exchange with the diversion server 125. However, this manner of providing the features is only exemplary and other manners may also be implemented.

The diversion server 125 may be configured to determine how a diversion is to be managed. Specifically, the diversion server 125 may be configured to identify when a diversion may be required at a primary airport, determine the one or more aircraft scheduled to use the primary airport that are to be diverted, determine one or more secondary airports to be used for the diversions, and determine recovery operations in view of these diversions. Accordingly, the diversion server 125 may perform pre-diversion operations, diversion operations (e.g., en route or underway), and post-diversion operations. As will be described in further detail below, the diversion server 125 may perform these operations for a window of time at the primary airport. For example, for the pre-diversion operations, the window of time may be a duration after a current time to enable the proactive approach to managing diversions. For diversion and post-diversion operations, the window of time may be a duration preceding and/or including the current time. Accordingly, as the current time moves, the window of time may also move (e.g., as a sliding window).

In resolving a gate conflict, the diversion server 125 may utilize a hybrid approach in which the diversion server 125 automatically determines when a diversion may be required or used. Specifically, the diversion server 125 may utilize a set of rules that define when a set of conditions at the primary airport may prompt the use of the diversion. As a hybrid approach, the user may be alerted of when this determination is made. The user may then manually determine how the diversion is to be performed by viewing dynamically updated information provided through the user interface prior to an actual need for the diversion arising. The diversion server 125 may also automatically determine how the diversion is to be performed. Specifically, the diversion server 125 may utilize a further set of rules that take into account the information pertaining to the primary airport, the secondary airport, the aircraft, etc. and determine a manner in which the diversion is to be performed to reach an agreeable result, particularly to the stakeholders. A corresponding alert or notification may be provided for this automated approach. The exemplary embodiments may be configured to utilize one or both approaches. For example, with the automated approach, the diversion server 125 may utilize the information and provide the corresponding outputs. With the hybrid approach, the diversion server 125 may perform the automated operations of determining when the diversion may be used and perform further automated operations in visualizing information for the user on the user interface such that a resolution input from the user may be received.

The data repository 130 may be any component that enables the diversion server 125 to store data used in managing a diversion. As those skilled in the art will understand, the diversion server 125 may utilize a relatively large amount of data in dynamically updating the user interface and managing diversions (at one or more primary airports). Accordingly, the diversion server 125 may store data in the data repository 130 as that data is being requested from the data sources 135-140, which are being updated through automatic determinations and manual entries. The data repository 130 may also be used to store data that is not immediately being used by the diversion server 125 in managing diversions. For example, the diversion server 125 may manage data being stored in the data repository from the data sources 135-140 as a sliding window so that data that may be used in managing diversions may be readily available.

The data sources 135-140 may represent any source of information that the diversion server 125 may use in managing diversions and providing the user interface. Initially, it is noted that the data sources 135-140 being represented as two separate sources is only exemplary. The system 100 may include any number of sources from which the diversion server 125 may receive information. For example, at least one of the data sources 135-140 may represent any source from which historical information may be received. In a first example of historical information, at least one of the data sources 135-140 may store time stamps associated with an aircraft corresponding to a respective position. In a second example of historical information, at least one of the data sources 135-140 may store map information (e.g., a layout of an airport, a layout of runways at the airport, etc.). In a third example of historical information, at least one of the data sources 135-140 may store historical weather information. Further types of historical information may include an aircraft type, a load factor, a gate, a runway, a filed route, a flown route, a density or congestion factor, a predictive sector loading, a region of interest, segment transit times, etc. In another example of information in the data sources 135-140, at least one of the data sources 135-140 may represent any source upon which live performance information may be received. It is noted that live performance information may relate to aircrafts or may also relate to current or predicted conditions. In a first example of the live performance information, at least one of the data sources 135-140 may store real-time information from passive and active radar systems as well as airport and airline information. In a second example of the live performance information, at least one of the data sources 135-140 may store weather forecasts. In a third example of the live performance information, at least one of the data sources 135-140 may store current runway conditions (e.g., construction areas, runway closings, etc.). Further types of live performance information may include a region of interest (e.g., a gate, a ramp, a taxiway, etc.) that may be defined by a geo-fence designed to capture activity in a specific geographical area, transit times, dwell times, an aircraft type, a filed route, flown route, a density or congestion factor, an actual sector loading, a region of interest, segment transit times (e.g., by aircraft, by previous flight activity including by similar type of aircraft, by the same route, by the same altitude, etc.), etc.

In a particular implementation of the data sources 135-140, one of the data sources 135-140 may provide a data feed from a passive radar system and/or an active radar system. An exemplary passive radar system may be, for example, the PASSUR System sold by PASSUR Aerospace, Inc. of Stamford, Conn. An exemplary active radar system may be, for example, an FAA feed. The information provided by the active and/or passive radar systems may include target data points or positions for a particular aircraft. These target data points may include, for example, the time (e.g., UNIX time), the x-position, the y-position, altitude, x-velocity component, y-velocity component, z-velocity component, the speed, the flight number, the airline, the aircraft type, the tail number, etc.

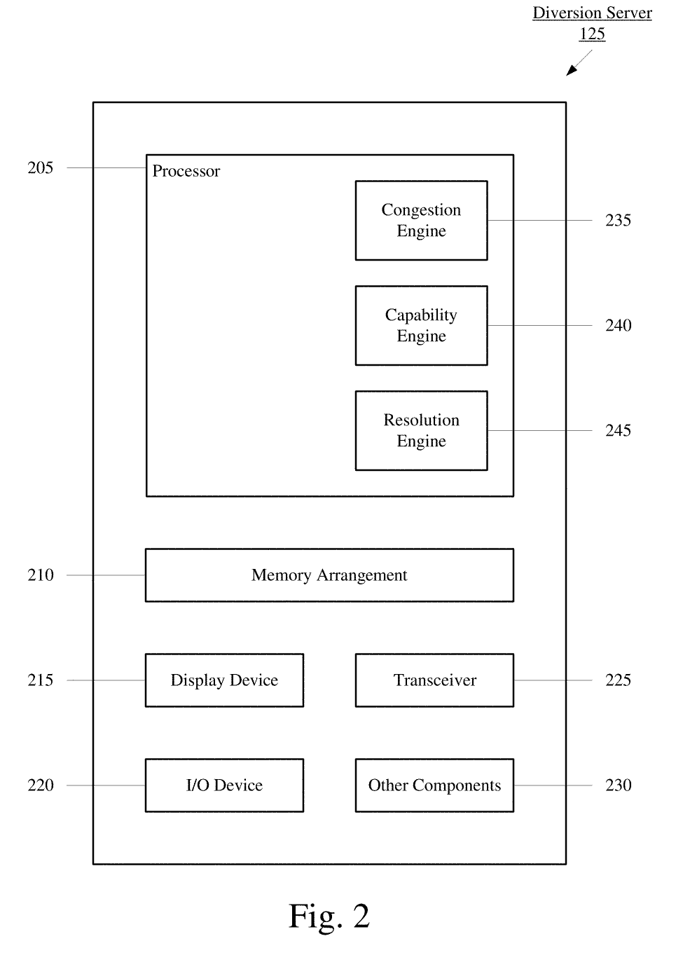

As noted above, the diversion server 125 may utilize the information from the data sources to manage diversions as well as provide a user interface of pertinent or requested information. FIG. 2 shows the diversion server 125 of the system 100 according to the exemplary embodiments. Although the diversion server 125 is described as a network component (specifically a server), the diversion server 125 may be embodied in a variety of hardware components such as a portable device (e.g., a tablet, a smartphone, a laptop, etc.), a stationary device (e.g., a desktop terminal), incorporated into the end user devices 105-115, incorporated into a website service, incorporated as a cloud device, etc. The diversion server 125 may include a processor 205, a memory arrangement 210, a display device 215, an input and output (I/O) device 220, a transceiver 225, and other components 230 (e.g., an imager, an audio I/O device, a battery, a data acquisition device, ports to electrically connect the diversion server 125 to other electronic devices, etc.).

The processor 205 may be configured to execute a plurality of applications of the diversion server 125. The processor 205 may utilize a plurality of engines including a congestion engine 235, a capability engine 240, and a resolution engine 245. As will be described in further detail below, the congestion engine 235 may be configured to determine when a diversion is likely to be used or required based on current or predicted conditions at a primary airport. The capability engine 240 may be configured to determine the capabilities (e.g., as a capability score) of the primary airport and associated secondary airports at a current time or at a future time (e.g., as a gridlock score). The resolution engine 245 may be configured to determine the diversion to be used at the primary airport for an aircraft scheduled to use the primary airport (e.g., the secondary airport to redirect the aircraft) based on the outputs of the congestion engine 235 and the capability engine 240.

It should be noted that the above noted engines each being an application (e.g., a program) executed by the processor 205 is only exemplary. The functionality associated with the engines 235-245 may also be represented as components of one or more multifunctional programs, a separate incorporated component of the diversion server 125 or may be a modular component coupled to the diversion server 125, e.g., an integrated circuit with or without firmware.

The memory 210 may be a hardware component configured to store data related to operations performed by the diversion server 125. The display device 215 may be a hardware component configured to show data to a user while the I/O device 220 may be a hardware component that enables the user to enter inputs. For example, an administrator of the diversion server 125 may maintain and update the functionalities of the diversion server 125 through user interfaces shown on the display device 215 with inputs entered with the I/O device 220. It should be noted that the display device 215 and the I/O device 220 may be separate components or integrated together such as a touchscreen. The transceiver 225 may be a hardware component configured to transmit and/or receive data via the communications network 120.

According to the exemplary embodiments, the diversion server 125 may be configured to enable users to optimize critical operational, financial, and/or customer service objectives. In a particular optimization that encompasses operational, financial, and customer service objectives, the diversion server 125 manages diversions that may be used whenever a primary airport experiences an internal or regional event. For example, the internal event may be due to events occurring within only the primary airport (e.g., delays, out of service events, etc.). The regional event may be an event that may cover more than just the primary airport (e.g., a weather event covering a multiple mile radius which may also affect secondary airports). By alerting users in advance to a need for a diversion using the hybrid approach or providing an automatically determined resolution using the automated approach (e.g., diverting an aircraft to a secondary airport capable of receiving the redirected flight), the diversion server 125 may maintain a minimum operating efficiency based on the current conditions and compensate for accumulating or sudden events that affect this efficiency. It is noted that the minimum operating efficiency may be dynamic as this metric may be a first value (e.g., with an internal event where aircraft are being serviced in an expected manner) or may be a second value (e.g., with an external event that may cause the airport to close such that no aircraft may be serviced at the primary airport).

Initially, as noted above, the diversion server 125 may also provide information to users on various user interfaces. Accordingly, the diversion server 125 may also include further engines such as an interface engine (not shown) that is configured to format and generate the user interfaces with available, current, pertinent, and/or relevant information. With regard to diversions, the user interfaces may display information that is directly or indirectly related to pre-diversion, diversion, and post-diversion operations. In describing the user interfaces and associated information below, the diversion server 125 may display the information in the user interfaces as well as also utilize any of this information (including metadata used in determining this information) in performing the operations, particularly when the automated approach or the automated portions of the hybrid approach are used.

In providing the user interfaces, the diversion server 125 may utilize information from the data sources 140 to predict likely diversion events during the window of time when the need for diversions is determined. In a first example, the information may include projected arrival and departure demand at the primary airport. This information may further include cancellations and delays. In a second example, the information may include projected imbalances in demand and/or capacity. In a third example, the information may include projected runway configurations. In a fourth example, the information may include projected arrival and departure rates. In providing this information for display, the user interfaces may show a viewable time-frame such as in a predetermined advanced time (e.g., 16 hours), a current hour, a predetermined previous time (e.g., 8 hours), etc. Accordingly, information that may contribute to the need for a diversion may be provided on the user interfaces to be viewed by users.

The diversion server 125 may utilize information from the data sources 140 to analyze aircraft holds, diversions underway, and total diversions at the primary (and secondary) airport during the window of time when the need for diversions is determined. In a first example, with aircraft holds, the information may include ETAs to a hold fix, a number of holds per airport, a number of aircraft (including identities), ETA to hold release, cumulative hold time per aircraft, etc. In a second example, with diversions underway, the information may include each aircraft that is being diverted or currently en route from a diversion as well as corresponding destinations (e.g., secondary airport, gate, runway, etc.). In a third example, with diversions on the ground (e.g., at the secondary airport), the information may include a number of these diverted aircraft on the ground, identities of each, a duration of the diversion at the secondary airport, a total number of diversions on the ground at each airport, etc.

The diversion server 125 may utilize information from the data sources 140 to visualize operations underway, at the terminal, and at airport surfaces during the window of time when the need for diversions is determined. In a user interface associated with this type of information, the user interface may visualize in graphical representations the details on each flight/aircraft, alerts for tarmac delayed aircraft, gate conflict alerts, delayed aircraft alerts and notifications, gate occupancy, estimated time ON (e.g., landing on a runway), estimated time IN (e.g., reach a gate), mandatory OFF time (e.g., taking off a runway), tracking by tail number, etc.

The diversion server 125 may utilize information from the data sources 140 to track airport capabilities during the window of time when the need for diversions is determined. In a user interface associated with this type of information, the user interface may show detailed statuses of airfield and terminal facilities, all active Notice to Airmen (NOTAMs), runway configurations, contact information, airport documentation, real-time communication windows (e.g., chat), links to various portals (e.g., International Air Transport Association (IATA) FAA command center portal), etc. This user interface may be used to manage diversion capability information at the airport associated with the user (e.g., at the primary airport to divert aircraft, at the secondary airport to receive diverted aircraft, etc.).

The diversion server 125 may utilize information from the data sources 140 to track and notify of diversions on ground status and actions needed during the window of time when the need for diversions is determined. In a first example, the user interface associated with this type of information may be used to show a visual indication of flights at risk for a Department of Transportation (DOT) Tarmac Delay Violation or aircraft that are ON but not IN. In a second example, the user interface associated with this type of information may be used to show priority flight lists (e.g., flights that have gate conflicts or are over a predetermined minimum time off gate such as 2 hours). In a third example, the user interface associated with this type of information may be used to show tarmac delays for detailed collaborative management of tarmac delayed flights.

The diversion server 125 may utilize information from the data sources 140 to monitor and provide information regarding weather during the window of time when the need for diversions is determined. As noted above, the weather may be an external event that affects a primary airport and potentially one or more secondary airports associated with the primary airport. The weather information may be based on a variety of different sources such as the National Weather Service. The weather information may also be shown using different systems such as terminal radar approach control (TRACON) (including associated levels), air route traffic control center (ARTCC), etc.

The diversion server 125 may provide the user interfaces with information such as those described above so that airports (e.g., primary and secondary) may manage diversions. The user interfaces may also enable information to be received manually from users to update the information shows in the user interfaces. Accordingly, the user interfaces provided by the diversion server 125 may enable information to be exchanged among the airports (and other stakeholders). For example, the user interfaces may ensure airlines (e.g., worldwide) are aware of airport status and National Airspace System (NAS) conditions. The user interfaces may also be used to enable airports to become aware of intent of airlines and other airports. Furthermore, through tying the information and user interfaces for information exchange, the IATA may be aware of and communicating what is occurring at airports.

Through incorporation of the above noted types of information, the diversion server 125 may be configured to show the highest level information requirements such that information being viewed by a user may be understood with relative ease. Thus, with the hybrid approach, the user may be able to provide resolution inputs or other inputs (e.g., a manually selected time frame in which to manage diversions). With the automated approach, the user may easily identify how the diversion server 125 has automatically determined the manner in which diversions are being managed for a selected primary airport. In providing this highest level information, the information may include diversion forecasts, diversion alerts, primary and secondary airport service capability, primary and secondary airport statuses, primary and secondary airport weather conditions, diversions underway per airport, diversions on the ground at each airport, diversions recovering at the primary and secondary airports, a total number of diversions currently in play (with corresponding information), and communications modules.

Returning to the above noted functionalities of the diversion server 125, the diversion server 125 may also be configured to receive user defined settings to provide the features of managing diversions. Specifically, when information is being provided to the user on the user interfaces, the user may indicate how and what information is to be provided. In a first example, the user may provide an input identifying the primary airport to which the management of diversions is being performed. In a second example, the user may provide the identities of the secondary airports to be associated with the primary airport. In a third example, the user may set load factors that drive estimated inbound passenger volumes (which may be used in determining congestion related metrics). In a fourth example, the user may provide weights for the factors driving a diversion (e.g., at the primary airport). In a fifth example, the user may provide weights for the factors driving an airport saturation such as a gridlock (e.g., at a secondary airport).

It is noted that the above manual inputs may be used for both the hybrid and automated approaches. For example, the identities of the primary and secondary airports may be used in the hybrid approach to provide the corresponding information on the user interfaces. The identities of the primary and secondary airports may also be used in the automated approach to provide the diversion resolution when a diversion is determined to be used. In another example, the load factors and weights for the factors driving the different metrics may be used by the diversion server 125 for the pre-diversion operations (as will be described in further detail below).

Returning to the engines of the diversion server 125, the congestion engine 235 may determine when a diversion is likely to be used or required based on current or predicted conditions at a primary airport. In this manner, the congestion engine 235 may identify one or more aircraft that is to be diverted based on the congestion at the primary airport. Accordingly, the congestion engine 235 may be used for pre-diversion operations. Using the pre-diversion operations to proactively use a diversion prior to a need for the diversion occurring, the capability engine 240 may determine the capabilities (e.g., as a capability score) of the primary airport and associated secondary airports. Through the output of the capability engine 240, a resolution for the diversion may be determined. Accordingly, the capability engine 240 may be used for the pre-diversion operations. In this manner, the resolution engine 245 may determine how to divert a selected aircraft from the primary airport to a determined secondary airport based on the capabilities of the secondary airports. Accordingly, the resolution engine 245 may be used for the pre-diversion operations. Although the engines 235-245 are used for pre-diversion operations, the engines 235-245 may incorporate information from pre-diversion phases, diversion phases, and post-diversion phases. That is, for a given window of time, an airport may be undergoing one or more of these diversion phases which may affect the manner in which diversions may be managed by the diversion server 125. Thus, the diversion server 125 is configured to consider all phases of a diversion in performing the pre-diversion operations. In describing the pre-diversion operations, the information associated with the pre-diversion, diversion, and post-diversion phases are described herein which provide the basis upon which the pre-diversion operations are performed.

In the pre-diversion phase, the diversion server 125 may utilize information associated with airport capabilities, aircraft holdings, holding analyses, weather conditions, projected arrival and departure rates, a projected runway configuration, projected imbalances in airport demand and capacity, reroutes, FAA programs, etc. By incorporating these types of information in the pre-diversion phase, respective users may primarily or secondarily take advantage of this information for corresponding purposes. As noted above, these types of information may contribute in some manner to performing pre-diversion operations used to proactively divert an aircraft prior to a need (and corresponding consequences) for the diversion arising.

The airport capabilities may enable airlines and airports with advance planning as diversions become a possibility. For example, airport system operations at the secondary airport, airport stations operations at the secondary airport, IATA, and the primary airport determining use of a diversion may benefit from this information. The airport capabilities of primary and secondary airports may include available gates from a total number of gates, gate gauges (e.g., wide/narrow), available tugs, available hard stands, fueling capability, deicing capability, CBP staffing levels and schedules, etc. The airport capability information may be provided on a proprietary user interface generated by the diversion server 125 such as through a popup window (as will be described in an exemplary implementation below).

The aircraft holdings that are underway may provide a leading indicator of possible diversions for all stakeholders. For example, airline system operations for both primary and secondary airports, airline station operations for both primary and secondary airports, airport airfield operations for both primary and secondary airports, airport terminal operations for both primary and secondary airports, the CBP at the secondary airport, the primary airport, airport concessionaires for both primary and secondary airports, and the IATA help desk for both primary and secondary airports may benefit from this information. The information associated with aircraft holdings may be provided on a diversion manager user interface and/or an air traffic control (ATC) procedure (ATCP) user interface generated by the diversion server 125.

The holding analyses and corresponding alerts may enable a determination of whether to divert early or avoid an unnecessary diversion. For example, the airline system operations may benefit from this information. The holding analyses and corresponding alerts may include a number of flights/aircraft on hold, a number and location of different hold fixes, time spent in hold per flight/aircraft, estimated time of release from hold per flight/aircraft, estimated time to hold fix per flight/aircraft, etc. The information associated with holding analyses and corresponding alerts may be provided on the diversion manager user interface.

The weather conditions (e.g., convective/winter weather) may be a leading indicator of possible diversions for all stakeholders at both the primary and secondary airports. For example, airline system operations for both primary and secondary airports, airline station operations for both primary and secondary airports, airport airfield operations for both primary and secondary airports, airport terminal operations for both primary and secondary airports, the primary airport, the CBP at the secondary airport, airport concessionaires for both primary and secondary airports, and the IATA help desk for both primary and secondary airports may benefit from this information. The information associated with aircraft holdings may be provided on the ATCP user interface generated by the diversion server 125.

The projected arrival and departure rates may be a leading indicator of possible diversions. For example, airline system operations for both primary and secondary airports, airline station operations for both primary and secondary airports, the primary airport, the IATA help desk for both primary and secondary airports, and the secondary airport operations may benefit from this information. The information associated with aircraft holdings may be provided on the ATCP user interface generated by the diversion server 125.

The projected runway configuration, the projected imbalances in airport demand and capacity, and the FAA programs may each be a leading indicator of possible diversions, particularly when used in conjunction with the holding information described above. For example, airline system operations for both primary and secondary airports, airline station operations for both primary and secondary airports, the primary airport, the IATA help desk for both primary and secondary airports, and the secondary airport operations may benefit from this information. The information associated with aircraft holdings may be provided on the ATCP user interface generated by the diversion server 125.

The reroutes may selectively be a leading indicator of possible diversions where certain types of reroutes provide such an indication. For example, airline system operations for both primary and secondary airports, airline station operations for both primary and secondary airports, airport airfield operations for both primary and secondary airports, airport terminal operations for both primary and secondary airports, and secondary airport operations may benefit from this information. The information associated with aircraft holdings may be provided on a web tracker user interface generated by the diversion server 125.

In the diversion phase, the diversion server 125 may utilize information associated with airline crew time-out by aircraft/flight, diversion by flight with destination, actual arrival demand at the primary and secondary airports, estimated passenger loads by aircraft/flight and totals by secondary airport, diversions on ground for all airlines, airport capability saturation, tarmac delay alerts, cancellation and delays, ongoing updates to capability of secondary airports, ongoing updates to various airline metrics, active arrival and departure demand, airport tarmac delay operational plans, secondary airport accommodation availability, airport contact lists of stakeholders, etc. By incorporating these types of information in the diversion phase, respective users may primarily or secondarily take advantage of this information for corresponding purposes. As noted above, these types of information may contribute in some manner to performing pre-diversion operations used to proactively divert an aircraft prior to a need (and corresponding consequences) for the diversion arising.

The airline crew time-out by aircraft/flight may alert secondary airports to a possibility of extended time-on-ground/remain overnight (RON) because of federal regulations (e.g., 13 C.F.R. Part 117). For example, secondary airport operations, a primary airport diversion desk, airline station operations for the secondary airport, airline dispatch, and CBP at the secondary airport may benefit from this information. The information associated with airline crew time-out by aircraft/flight may be provided on a proprietary user interface generated by the diversion server 125.

The diversion by flight with destination may alert secondary airports of inbound diversions, may alert the primary airport to diversions away, and show a diversion distribution. For example, secondary airport operations, a primary airport diversion desk, CBP at the secondary airport, airport terminal operations, security at the secondary airport, airline stations operations, and airport concessionaires at the secondary airport may benefit from this information. The information associated with diversion by flight with destination may be provided on a diversion manager user interface generated by the diversion server 125.

The actual arrival demand at the primary and secondary airports may show diversion demand in relation to overall demand. This information may also show at what time to expect any added demand. The demand information may be directly correlated at least in part to determining when a diversion may be necessary at a current or predicted time. Accordingly, any stakeholder may benefit from this information. The information associated with the actual arrival demand may be provided on a proprietary user interface generated by the diversion server 125.

The estimated passenger loads by aircraft/flight and totals by secondary airport may provide indications of passenger demand and resources needed at secondary airports. For example, secondary airport operations, CBP at the secondary airport, and airport concessionaires may benefit from this information. The information associated with estimated passenger loads may be provided on a proprietary user interface generated by the diversion server 125.

The diversions on ground (e.g., by airport, by airline, by aircraft type, etc.) for all airlines may indicate a diversion spread such as how evenly diversions are being distributed to airports (e.g., to secondary airports relative to a primary airport, to all airports in a geographically defined area, etc.). For example, a primary airport diversion desk, airline system operations for the secondary airport, airline stations operations for the secondary airport, secondary airport operations, IATA help desk, the primary airport, and the CBP may benefit from this information. The information associated with diversions on ground may be provided on a diversion manager user interface generated by the diversion server 125.

The airport capability saturation may show a current status of actual versus ideal airport ability to accommodate diversions. It is noted that this is not necessarily a measure of diversion capacity. Those skilled in the art will understand that all airports must accommodate a diversion if required by flight crew regardless of ideal capability status. A primary airport diversion desk, airlines system operations at the secondary airport, airline stations operations at the secondary airport, IATA help desk, secondary airport operations, airport concessionaires, ground transportation, the CBP, and security may benefit from this information. The information associated with airport capability saturation may be provided on a proprietary user interface generated by the diversion server 125.

The tarmac delay alerts may alert to aircraft at risk of DOT 3 or 4 hour violations and associated passenger issues. For example, airline system operations at the secondary airport, airline stations operations at the secondary airport, secondary airport operations, a primary airport diversion desk, secondary airport operations, airport concessionaires, ground transportation, the CBP, and security may benefit from this information. The information associated with tarmac delay alerts may be on a tarmac delay manager user interface or a web tracker user interface.

The cancellation and delays may show primary and secondary airports an improved representation of expected diversion and recovery demand. For example, a primary airport diversion desk, airline stations operations, the CBP at the secondary airport, airport concessionaires, the primary airport, airport terminal operations, and IATA help desk may benefit from this information. The information associated with cancellation and delays may be provided on a ATOP user interface.

The ongoing updates to capability of secondary airports may provide further detail on each airport's changing capabilities as diversions progress. The updated capabilities may include information that benefits any stakeholder receiving airport capability information. The information associated with ongoing updates to capability of secondary airports may be provided on a proprietary user interface.

The ongoing updates to various airline metrics may provide indications of duration and projected end of diversion events. The metrics may include convective/winter weather information, projected arrival and departure rates, projected runway configuration, projected imbalances in airport demand and capacity, etc. The primary airport diversion desk, airline system operations, airline stations operations, secondary airport operations, IATA help desk, airport concessionaires, ground transportation, the CBP, and security may benefit from this information. The information associated with the ongoing updates to airline metrics may be provided on a ATOP user interface.

The active arrival and departure demand may include ground stops at the primary airport that help slow a flow of aircraft. However, there may still be a plurality of active demand on an aircraft's way to a primary airport which may impact an existing holding pattern or cause additional holding after the first periods of holding are cleared. Where the volume is coming from is also an important factor. Different fixes may be impacted more than others and the primary airport may fix balance to reduce the holding at certain fixes which leads to fuel concerns. The primary airport diversion desk and airline system operations may benefit from this information. The information associated with active arrival and departure demand may be provided on a ATOP user interface.

The airport tarmac delay operational plans, the secondary airport accommodation availability, and the airport contact lists of stakeholders may each benefit a plurality of stakeholders. Specifically, the airport tarmac delay operational plans may enable all stakeholders access to mandatory airport plan to deal with extended tarmac delay flights. The secondary airport accommodation availability (e.g., hotel room availability) may provide indications on ability to accommodate passengers of flights/aircraft that are RON. The airport contact lists may provide a lookup to contact key stakeholders at the primary airport, the secondary airport, airline station operations, and airline system operations. The information associated with these factors may be provided on a proprietary user interface.

In the post-diversion phase, the diversion server 125 may utilize information associated with flight recovering back to the primary airport, cancellations, the ground delay program (GDP) at the primary airport, CBP staffing the primary airport, concession status at the primary airport, airfield capabilities at the primary airport, weather at the primary and secondary airports, ground transportation status at the primary airport, etc. By incorporating these types of information in the pre-diversion phase, respective users may primarily or secondarily take advantage of this information for corresponding purposes. As noted above, these types of information may contribute in some manner to performing post-diversion operations used to proactively divert an aircraft prior to a need (and corresponding consequences) for the diversion arising.

The flight recovering back to the primary airport may provide the primary airport and airline station operations advance notification of diversion recovery demand to enable for improved passenger processing and experience. This information may include proposed departure time, ETA, summary of aircraft types recovering (e.g., wide/narrow/domestic/international), estimated passenger loads on recovering flights/aircraft, etc. The primary airport diversion desk, airline system operations, airport terminal operations, the CBP, airline stations operations, and IATA help desk may benefit from this information. The information associated with the flight recovering back to the primary airport may be provided on a proprietary user interface.

The cancellations, the GDP at the primary airport, and the CBP staffing the primary airport may each benefit the primary airport diversion desk, airline system operations, airport terminal operations, the CBP, and airline stations operations. The cancellations and the GDP at the primary airport may further benefit IATA help desk. Specifically, the cancellations may assist the primary airport to determine recovery demand. The GDP at the primary airport may relate to how diverted flights get priority but must still comply with Expect Departure Clearance Time (EDCT). This condition may lead to additional delays at the gate or on the ramp at the secondary airport. The CBP staffing the primary airport may provide diversion recovery capability and passenger experience information. These factors may be provided on a ATCP user interface or a proprietary user interface.

The concession status at the primary airport, the airfield capabilities at the primary airport, the weather at the primary and secondary airports, and the ground transportation status at the primary airport may each benefit the primary airport diversion desk, airport terminal operations, airline stations operations, and airline system operations. The weather at the primary and secondary airports may further benefit IATA help desk and the CBP. Specifically, the concession status at the primary airport, the airfield capabilities at the primary airport, and the ground transportation status at the primary airport may provide diversion recovery capability and passenger experience information. The weather at the primary and secondary airports may indicate progress and potential for recovery. For example, in the winter, snow and ice may cause problems on the surface and reduce gates and parking. In the summer, thunderstorms may cause the same problems at the secondary airport as they might at the primary airport. These factors may be provided on a proprietary user interface.

It is noted that the above types of information for the pre-diversion, diversion, and post-diversion phases may be associated with the pre-diversion operations in any manner as contributing factors to managing a diversion. As those skilled in the art will appreciate, a primary airport may utilize any number of factors in any number of ways. For example, as described above, a user may provide weights associated with these factors. Thus, even though two airports may utilize the same set of factors, the airports may reach different resolutions in managing a diversion. Specifically, as each airport may utilize a respective set of weights for the factors, each factor may provide a different degree as a contributing factor. It is again noted that manually received weights are only exemplary and the exemplary embodiments may be configured to automatically determine the weights (e.g., by receiving objectives and goals associated with an airport).

By utilizing the above described contributing factors (along with any corresponding weights), the exemplary embodiments may be configured to determine a capability of the primary and secondary airports. For example, a capability score may be determined. When determined for the primary airport, the capability score may identify when a diversion may be used. For example, if the capability score is at least a predetermined threshold associated with the primary airport (e.g., pertaining to capacity or whether the primary airport operates at a minimum operating efficiency), the diversion server 125 may determine that the diversion may not be necessary. In contrast, if the capability score is under the predetermined threshold associated with the primary airport, the diversion server 125 may determine that the diversion may be used. The diversion server 125 may schedule one or more diversions until the capability score of the primary airport has reached at least the predetermined threshold associated with the primary airport.

When determined for the secondary airports, the capability score may identify whether an aircraft may be diverted to a selected one of the secondary airports. For example, if the capability score for a selected secondary airport is under a predetermined threshold associated with the secondary airports (although a respective threshold for the selected secondary airport may also be used), the diversion server 125 may determine that the selected secondary airport is not available for a diversion. If the capability score for the selected secondary airport is at least the predetermined threshold associated with the secondary airports, the diversion server 125 may determine that the selected secondary airport is available for a diversion.

Also noted above, the capability score used for the secondary airports may include a gridlock component or a separate gridlock score. Accordingly, using the above contributing factors (and associated weights), the gridlock score may be determined which indicates an expected gridlock state at the secondary airport. Assuming an equal capability score between secondary airports and/or assuming availability of these secondary airports for a diversion, the gridlock score may provide a further indication for a selection of the secondary airport for a diversion. Specifically, the secondary airport that has a gridlock under a predetermined or minimal threshold may be selected such that a diversion may be accommodated or have a minimal impact on operations at the secondary airport (relative to other available secondary airports).

It is also noted that the diversion server 125 may include further engines to perform the diversion operations and the post-diversion operations using any of the above noted information. As noted above with regard to the diversion phase and the post-diversion phase, the diversion server 125 may be configured to perform the corresponding operations for the primary airport in a substantially similar manner as how the information is generated and used for the pre-diversion operations as described above. In this manner, the diversion server 125 may also provide, implement, or recommend recovery measures that may be used for the primary airport when a diversion is used for an aircraft redirected from the primary airport or for an aircraft being redirected to the primary airport.

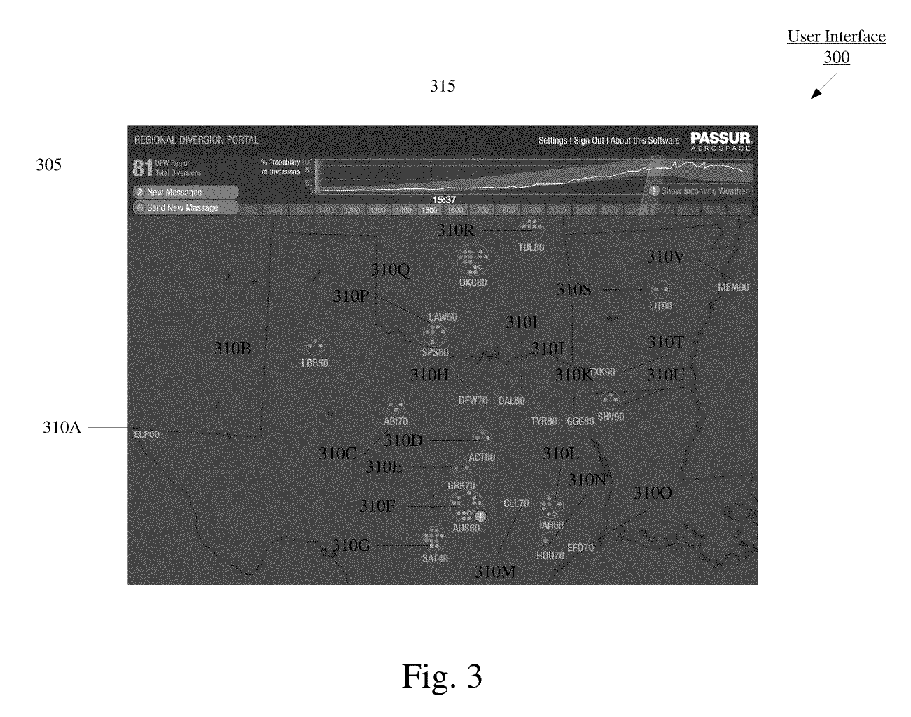

The above describes exemplary factors that may be considered in performing pre-diversion operations to determine when a diversion may be necessary at a primary airport, selecting one or more aircraft to be diverted from the primary airport, determine which secondary airports are associated with the primary airport (e.g., through a manual or automatic determination), selecting a secondary airport for one of the selected aircraft, and scheduling a corresponding diversion. The information for the pre-diversion, diversion, and post-diversion phases described above may also be illustrated in various user interfaces. The representation of the information may be particularly be used when a user provides manual inputs (e.g., with a hybrid approach). FIGS. 3-7 illustrate exemplary user interfaces.

FIG. 3 shows an exemplary user interface 300 provided by the diversion server 125 of the system 100 of FIG. 1 according to the exemplary embodiments. The user interface 300 illustrates a geographic area including boundaries (e.g., state boundaries). The user interface 300 includes a region identifier 305. For example, the region identifier 305 may be relative to a particular airport. The user interface 300 may also include a graphical indicator 315 that shows a probability of a diversion or use of a diversion over time. As noted above, the diversion server 125 may determine when a diversion may be used in a proactive manner. Accordingly, the graphical indicator 315 may show a dynamically updated expected need or use of diversions, particularly as diversions are scheduled, performed, or recovered. The user interface 300 may further show a plurality of airports 310 in the geographic area. For example, airports 310A-V may be shown in the geographic area. As shown, airports 310A-0 may be located in a first state, airports 310P-R may be located in a second state, airports 310S, T may be located in a third state, airport 310U may be located in a fourth state, and airport 310V may be located in a fifth state. For illustrative purposes, for a given one of the airports 310A-V being a primary airport, the other airports 310A-V may be a possible set of secondary airports. Specifically, the primary airport may be centrally located among the airports 310A-V.

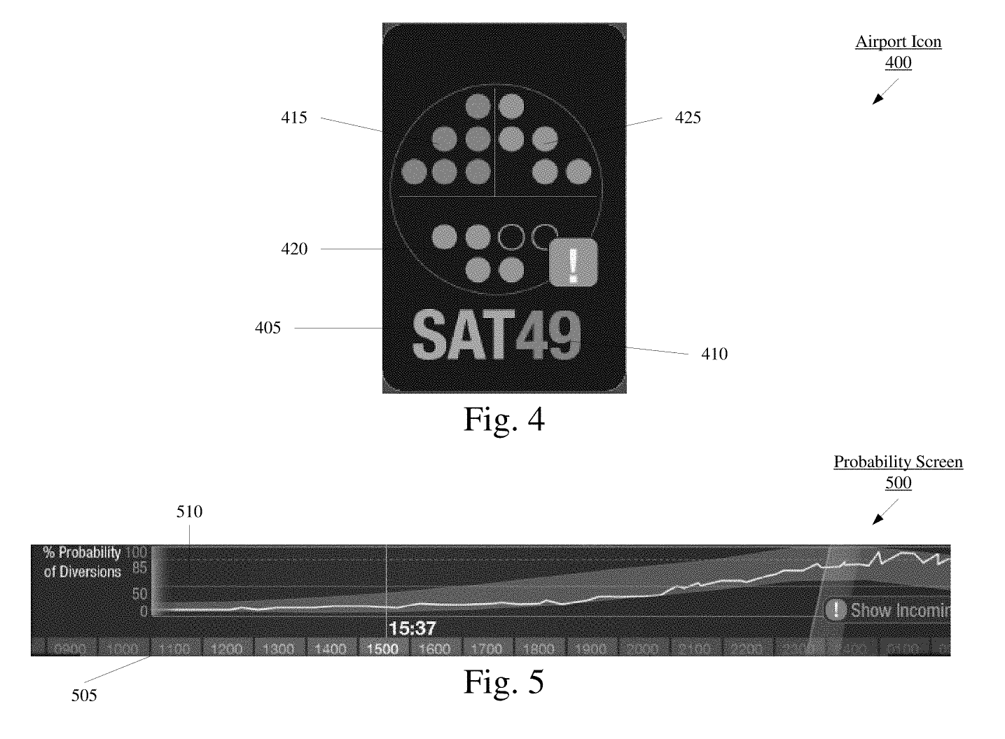

FIG. 4 shows an exemplary airport icon 400 in the user interface 300 of FIG. 3 according to the exemplary embodiments. The airport icon 400 may be a respective graphical representation shown with the airports 310A-V including information associated with diversions at the airport. The airport icon 400 may include an airport identifier 405. The airport identifier 405 may include a load indicator 410 that identifies a load of diversions being handled by the selected airport. For example, a first load indicator 410 (e.g., green color) may indicate an amount of diversions under a first threshold; a second load indicator 410 (e.g., yellow color) may indicate an amount of diversions above the first threshold but below a second threshold; and a third load indicator 410 (e.g., red color) may indicate an amount of diversions above the second threshold. It is noted that three levels of diversions is only exemplary and other degrees of diversions may be indicated using the load indicator 410.

The airport icon 400 may also include a breakdown of diversions occurring at the airport. As shown, there may be three types of diversions: diversions underway 415, diversions on the ground 420, and diversions recovering 425. As noted above, the diversions underway 415 may relate to aircraft that are diverted to the airport and are in transit toward the airport, the diversions on the ground 420 may relate to aircraft that are diverted to the airport and are located at the airport, and the diversions recovering 425 may relate to aircraft that have completed a diversion (e.g., returning to the primary airport).

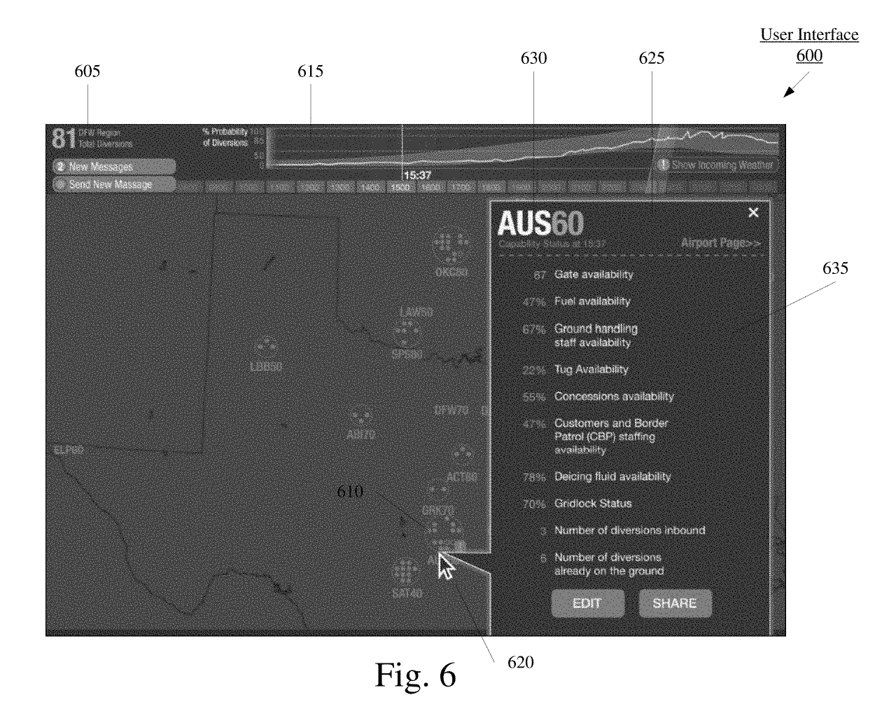

FIG. 5 shows an exemplary probability screen 500 in the user interface 300 of FIG. 3 according to the exemplary embodiments. The probability screen 500 may correspond to the graphical indicator 315. As shown, the probability screen may include different information such as a timeline 505, and a curve 510 representing a probability of a diversion over time. Through incorporating of the above described types of information, the probability screen 500 may enable a user to view when a diversion may be scheduled proactively to alleviate a potential need for a diversion.

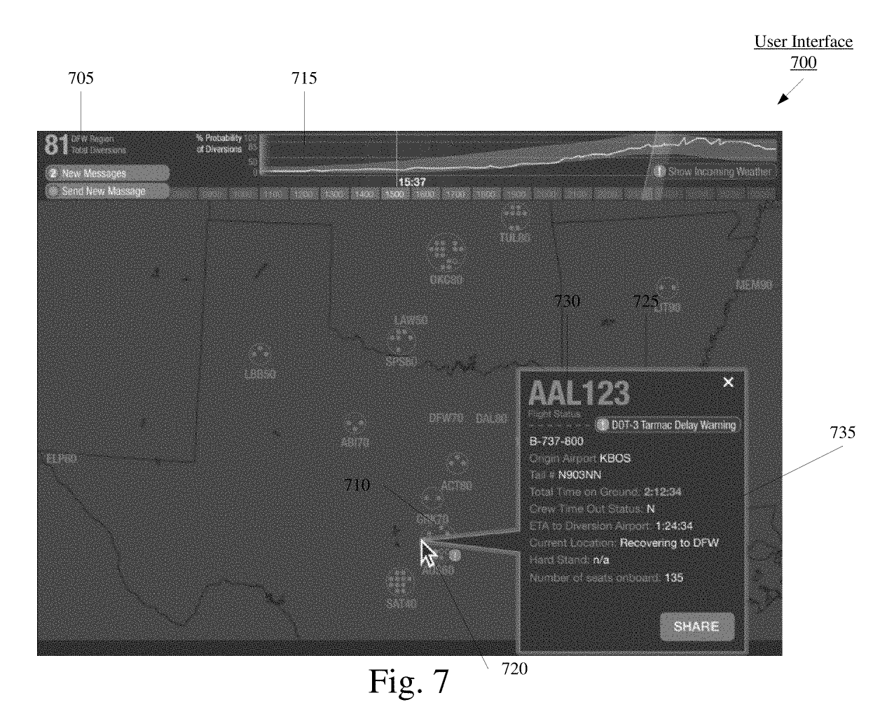

FIG. 6 shows an exemplary user interface 600 with an airport window 625 according to the exemplary embodiments. The user interface 600 may be substantially similar to the user interface 300. Accordingly, the user interface 600 may also include a region identifier 605 (substantially similar to the region identifier 305), an airport 610 (substantially similar to the airport 310), and a graphical indicator 615 (substantially similar to the graphical indicator 315). The user interface 600 also shows a user input 620 (e.g., a mouse cursor) that selects the airport 610 so that the airport window 625 is shown on the user interface 600. In this exemplary embodiment, the airport window 625 may show various information including an airport identifier 630 in a substantially similar manner as the airport identifier 405 (including the load indicator 410). The airport window 625 may also show various capability status information 635 (e.g., gate availability, fuel availability, ground handling staff availability, tug availability, concessions availability, CBP staffing availability, deicing fluid availability, gridlock status, number of diversions inbound, number of diversions already on the ground, etc.).

FIG. 7 shows an exemplary user interface 700 with an aircraft window 735 according to the exemplary embodiments. The user interface 700 may be substantially similar to the user interface 300. Accordingly, the user interface 700 may also include a region identifier 705 (substantially similar to the region identifier 305), an airport 710 (substantially similar to the airport 310), and a graphical indicator 715 (substantially similar to the graphical indicator 315). The user interface 700 also shows a user input 720 that selects an aircraft in the airport icon of the airport 710. In this exemplary embodiment, the aircraft window 735 may show various information including an aircraft identifier and aircraft details (e.g., origin airport, tail number, total time on ground, crew time-out status, ETA to secondary airport, current location, hard stand, number of seats onboard, etc.).

The user interface may also be configured to show other types of information. In a first example, a user may show transit lines for diverted aircraft to the secondary airports 310A-V that were scheduled to the primary airport. Specifically, each transit line may correspond to a specific aircraft that is diverted to one of the secondary airports 310A-V. In a second example, a user may show transit lines for diverted aircraft that are recovering and heading to the primary airport. Specifically, each transit line may correspond to a specific aircraft that has recovered from one of the secondary airports 310A-V.

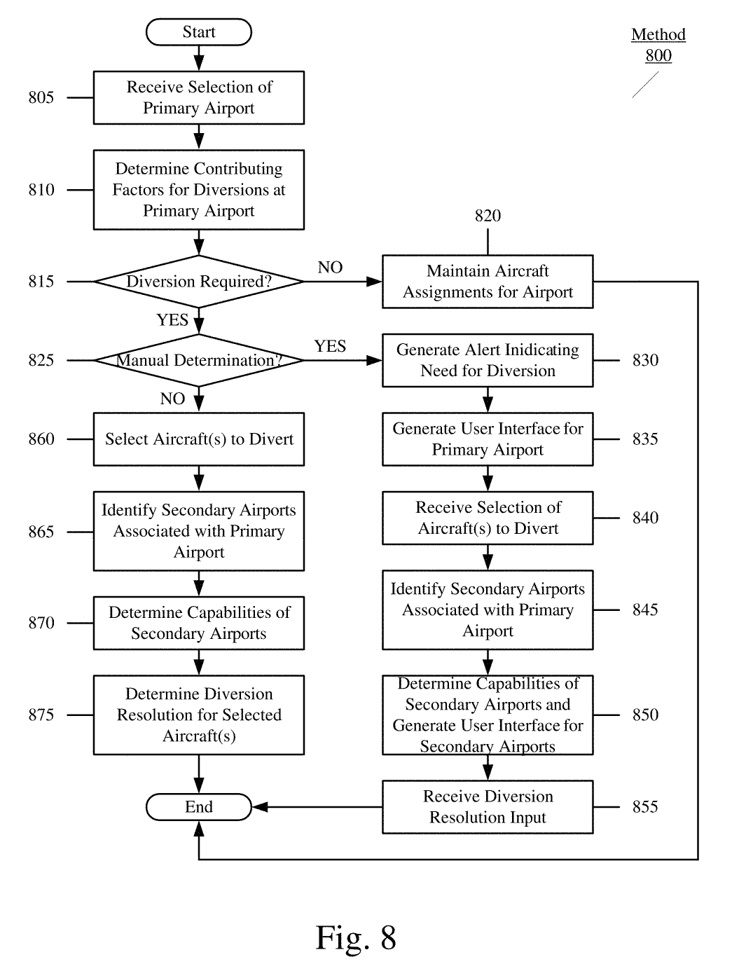

FIG. 8 shows a method 800 of managing diversions according to the exemplary embodiments. Specifically, the method 800 may relate to when a diversion of an aircraft from a primary airport to a secondary airport is identified and the manner in which the diversion is to be used is determined. The method 800 will be described from the perspective of the diversion server 125 utilizing an automated approach in which the output is a determination of the diversion (when identified). The method 800 will also be described with regard to the system 100 of FIG. 1 and the diversion server 125 of FIG. 2. It is again noted that it may be assumed that resolutions within the primary airport may be exhausted or unavailable and the diversion is to be used instead.

In 805, the diversion server 125 receives a selection of a primary airport. For example, a user may provide a manual input of a desired primary airport for which diversion information is to be determined or shown. It is noted that the selection of a primary airport is only exemplary. The diversion server 125 may be configured to determine diversion information and manage diversions for each airport that the diversion server 125 may be assigned. Accordingly, the selection of a primary airport may be a final operation to filter all the diversion information and show only the diversion information corresponding to the selection.

In 810, the diversion server 125 determines contributing factors for diversions at the selected primary airport. As described above, there may be a wide variety of different types of contributing factors that are involved in managing diversions for a primary airport. For example, the types of factors may correspond to information linked to pre-diversion, diversion, and post-diversion phases. Furthermore, the contributing factors may have manually or automatically determined weights that indicate the degree to which the contributing factors are to be considered in using a diversion.

In 815, the diversion server 125 determines whether a diversion is required or to be used in a proactive manner. As described above, a diversion may be used for a variety of reasons such as maintaining a minimum operating efficiency at the primary airport or compensating for an internal/external event at the primary airport. If a diversion is not necessary, the diversion server 125 continues to 820 where aircraft assignments for the primary airport are maintained. However, if the diversion is to be used proactively, in 825, the diversion server 125 determines if a hybrid approach is to be used by continuing to 830 or if an automated approach is to be used by continuing to 860.

With the hybrid approach in which manual inputs are received and is incorporated in the management of diversions, in 830, the diversion server 125 may generate an alert for indicating a need or use for a diversion. Specifically, based on the determination in 810, the diversion server 125 may generate a corresponding alert or notification so that a user viewing the user interfaces generated by the diversion server 125 may be aware that a diversion should be proactively scheduled. In this manner, the alert may be a recommendation for the diversion which may also include further details of the diversion to be used. Accordingly in 835, the diversion server 125 generates the user interface for the primary airport (e.g., the user interface 300). In 840, the diversion server 125 may receive a selection of one or more aircraft to divert to a respective secondary airport (e.g., based on the alert). In 845, the diversion server 125 identifies the secondary airports associated with the primary airport. The secondary airports may also be shown in the user interface that was generated in 835 such that corresponding diversion information for these secondary airports may be shown or selected for viewing. In 850, the diversion server 125 determines the capabilities of the secondary airports and generates user interfaces for the secondary airports (e.g., using an airport icon 400, an airport window 625, or an aircraft window 735). Specifically, a capability score may be determined (e.g., a secondary airport having a minimum capability may be selected) as well as a gridlock score (e.g., a secondary airport being under a maximum gridlock level may be selected). Based on the information being shown, the user may make a selection to schedule a diversion. Thus, in 855, the diversion server 125 receives a diversion resolution input. As noted above, by scheduling a diversion, the user interface may be updated such as with the graphical representation 315, by adding a transit line for a diversion underway, by adding a transit line for a recovering diversion, etc.

With the automated approach in which the diversion server 125 implements and schedules diversions and notifies users of the diversions, in 860, the diversion server 125 may select an aircraft to divert from the primary airport. The selection of the aircraft may be based on a variety of factors such as an expected gate, terminal, runway, etc. that may not be available in a timely manner. Once the aircraft to be diverted are selected, in 865, the diversion server 125 identifies the secondary airports that are associated with the primary airport in a substantially similar manner as in 845. In 870, the diversion server 125 determines the capabilities of the secondary airports in a substantially similar manner as in 850 such as determining a capability score and/or a gridlock score. In 875, the diversion server 125 determines the diversion resolution for the selected aircraft so that the minimum operating efficiency may be maintained or the internal/external factor may be compensated.

The exemplary embodiments describe a device, system, and method for managing a diversion for aircraft whose destination is at a primary airport. For a variety of reasons at the primary airport, a diversion may enable the primary airport to return to an acceptable operating efficiency. By determining contributing factors and corresponding weights to identify when a diversion may be used in a proactive manner to achieve the acceptable operating efficiency, an aircraft may be selected to be diverted from the primary airport in a proactive manner. By determining secondary airport capabilities to accommodate the aircraft being redirected, a secondary airport may be selected for the diversion. Once the aircraft has recovered at the secondary airport, the aircraft may return to the primary airport to process and service the next flight slated for the aircraft. However, having used the diversion, the primary airport may provide an acceptable level of service to all stakeholders (e.g., airline, crew, passengers, etc.).

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the calculation engine may be a program containing lines of code stored on a non-transitory computer readable storage medium that, when compiled, may be executed on a processor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
at a diversion server:
determining whether a diversion is to be used for an aircraft based on a primary expected operating capability of a primary airport that is a destination for the aircraft in transit;
when a diversion is to be used, selecting a secondary airport to which the aircraft is to be diverted, the secondary airport being selected based on a secondary expected operating capability; and
scheduling the diversion for the aircraft to the secondary airport.

2. The method of claim 1, wherein the primary airport is associated with a plurality of secondary airports.

3. The method of claim 2, wherein the secondary airports are based on a geographic criteria relative to the primary airport.

4. The method of claim 1, wherein the diversion is to be used when the primary airport has an expected internal event, an expected external event, or a combination thereof.

5. The method of claim 4, wherein the internal event affects only the primary airport, the internal event being associated with a handling capacity.

6. The method of claim 4, wherein the external event is independent of the primary airport, the external event being associated with a weather condition.

7. The method of claim 1, wherein the primary and secondary expected operating capabilities are based on pre-diversion phase information, diversion underway phase information, post-diversion phase information, or a combination thereof.

8. The method of claim 1, wherein the secondary airport is selected based on an expected gridlock at the secondary airport being under a predetermined maximum gridlock level.

9. The method of claim 1, further comprising:
generating a user interface showing a geographic region including the primary and secondary airports, the user interface including an airport icon for the secondary airport illustrating a diversion capacity being serviced.

10. The method of claim 9, wherein the user interface shows a graphical representation illustrating an expected probability of using the diversion at a specified time, the expected probability being based on the primary expected operating capability at the specified time.

11. A diversion server, comprising:
a transceiver configured to receive an identification of a primary airport, the primary airport being a destination for an aircraft in transit; and
a processor determining whether a diversion is to be used for the aircraft based on a primary expected operating capability of the primary airport, when a diversion is to be used, the processor selecting a secondary airport to which the aircraft is to be diverted, the secondary airport being selected based on a secondary expected operating capability, the processor scheduling the diversion for the aircraft to the secondary airport.

12. The diversion server of claim 11, wherein the primary airport is associated with a plurality of secondary airports.

13. The diversion server of claim 12, wherein the secondary airports are based on a geographic criteria relative to the primary airport.

14. The diversion server of claim 11, wherein the diversion is to be used when the primary airport has an expected internal event, an expected external event, or a combination thereof.

15. The diversion server of claim 14, wherein the internal event affects only the primary airport, the internal event being associated with a handling capacity.

16. The diversion server of claim 14, wherein the external event is independent of the primary airport, the external event being associated with a weather condition.

17. The diversion server of claim 11, wherein the primary and secondary expected operating capabilities are based on pre-diversion phase information, diversion underway phase information, post-diversion phase information, or a combination thereof.

18. The diversion server of claim 11, wherein the secondary airport is selected based on an expected gridlock at the secondary airport being under a predetermined maximum gridlock level.

19. The diversion server of claim 11, wherein the processor further generates a user interface showing a geographic region including the primary and secondary airports, the user interface including an airport icon for the secondary airport illustrating a diversion capacity being serviced.

20. A method, comprising:
at a diversion server:
receiving an identification of a primary airport, the primary airport being a destination for an aircraft in transit;
determining whether a diversion is to be used for the aircraft based on a primary expected operating capability of the primary airport;
when a diversion is to be used, generating a notification to be shown on a user interface to alert a user for the use of a proactive diversion; and
receiving a diversion resolution input indicating a secondary airport to which the primary airport is to be diverted.
